(19) United States
(12) Patent Application Publication
(10) Pub. No.: US 2010/0171329 A1
(43) Pub. Date: Jul. 8, 2010

(54) Lever and Pull Handle Arrangement for a Door

(75) Inventors: Harris Lambrou, Blackburn (AU); Sajan K. Velandi, Blackburn (AU); Ian Bartos, Blackburn (AU)

Correspondence Address: THE WEBB LAW FIRM, P.C., 700 KOPPERS BUILDING, 436 SEVENTH AVENUE, PITTSBURGH, PA, 15219, US

(73) Assignee: GAINSBOROUGH HARDWARE INDUSTRIES LIMITED, Blackburn (AU)

(21) Appl. No.: 12/683,558

(22) Filed: Jan. 7, 2010

(30) Foreign Application Priority Data
Jan. 7, 2009 (AU) 2009900068

(51) Int. Cl. E05B 3/00

(52) U.S. Cl. 292/336.3

(57) ABSTRACT

A lever and pull handle arrangement (10a) for a door (12). The arrangement (10a) includes a lever (20) and an elongate pull handle (14). The lever (20) is adapted for actuating a latch and/or lock assembly (18) and has a longitudinal axis and a rotational axis. The elongate pull handle (14) has a longitudinal axis. The lever (20) and the handle (14) are mountable on the door (12) with their longitudinal axes substantially aligned and, when viewed in the direction of the rotational axis towards the door (12), with the handle (14) substantially concealing the lever (20) from view. Put another way, the lever (20) is positioned between the door (12) and the handle (14).

### FIELD OF THE INVENTION

The present invention relates to a lever and pull handle arrangement for a door, the lever being adapted for actuation of a latch, lock or combination latch/lock mechanism.

The present invention is suitable for doors in both commercial and domestic applications and is applicable to both internal and external doors.

### BACKGROUND OF THE INVENTION

The opening and closing of many types of latchable and/or lockable doors is in response to pivoting movement of a knob or lever on one or both sides of the door. The movement of the knob or lever is transmitted to a bolt, via a latch, lock or combination latch/lock mechanism.

In many buildings, the use of elongate pull handles on doors is desirable for both aesthetics and functionality. However, the use of elongate pull handles on latchable and/or lockable doors is problematic due to the pull handles leaving little or no space for the actuating knob/lever, or require the handle or the knob/lever to be inconveniently positioned.

### OBJECT OF THE INVENTION

It is the object of the invention to provide a lever and pull handle arrangement permitting the installation and convenient use of an elongate pull handle on a latchable and/or lockable door.

### SUMMARY OF THE INVENTION

Accordingly, in a first aspect, the present invention provides a lever and pull handle arrangement for a door, the arrangement including:

a lever adapted for actuating a latch and/or lock assembly, the lever having a longitudinal axis and a rotational axis; and

an elongate pull handle having a longitudinal axis,

wherein the lever and the pull handle are mountable on the door with their longitudinal axes substantially aligned and, when viewed in the direction of the rotational axis towards the door, with the pull handle substantially concealing the lever from view.

In a second aspect, the present invention provides a lever and pull handle arrangement for a door, the arrangement including:

a lever adapted for actuating a latch and/or lock assembly, the lever having a longitudinal axis; and

an elongate pull handle having a longitudinal axis,

wherein the lever and the pull handle are mountable on the door with the longitudinal axes of the lever and pull handle substantially aligned and with the lever positioned between the door and the pull handle.

In one form, the pull handle is preferably mounted to the door with its longitudinal axis vertical. When in the rest position, the lever is preferably mounted to the door with its longitudinal axis vertical.

In another form, the pull handle is preferably mounted to the door with its longitudinal axis horizontal. When in the rest position, the lever is preferably mounted to the door with its longitudinal axis horizontal.

In one form, the arrangement includes a key cylinder positioned to one side of the handle. In another form, the arrangement includes a key cylinder positioned beneath the handle.

In a third aspect, the present invention provides a lever and pull handle arrangement for a door, the arrangement including:
a lever adapted for actuating a latch and/or lock assembly, the lever having a longitudinal axis that is vertical when in the rest position; and
an elongate pull handle having a longitudinal axis that is vertical,
wherein the lever and the pull handle are mountable on the door with, when viewed in the direction of the front of the door, the pull handle substantially concealing the lever.

In a fourth aspect, the present invention provides a lever and pull handle arrangement for a door, the arrangement including:

a lever adapted for actuating a latch and/or lock assembly, the lever having a longitudinal axis that is horizontal when in the rest position; and

an elongate pull handle having a longitudinal axis that is horizontal,

wherein the lever and the pull handle are mountable on the door with, when viewed in the direction of the front of the door, the pull handle substantially concealing the lever.

The longitudinal axes of the lever and the pull handle are preferably substantially aligned.

In a fifth aspect, the present invention provides a lever and pull handle arrangement for a door, the arrangement including:

a lever adapted for actuating a latch and/or lock assembly, the lever having a longitudinal axis that is vertical when in the rest position; and
an elongate pull handle having a longitudinal axis that is vertical,
wherein the lever and the pull handle are mountable on the door with the longitudinal axes of the lever and the pull handle substantially aligned and with the lever positioned between the door and the pull handle.

In a sixth aspect, the present invention provides a lever and pull handle arrangement for a door, the arrangement including:

a lever adapted for actuating a latch and/or lock assembly, the lever having a longitudinal axis that is horizontal when in the rest position; and
an elongate pull handle having a longitudinal axis that is horizontal,
wherein the lever and the pull handle are mountable on the door with the longitudinal axes of the lever and the pull handle substantially aligned and with the lever positioned between the door and the pull handle.

The pull handle preferably includes a pair of legs adapted to space the pull handle from the door.

The lever is preferably mounted with its outer surface in close proximity, for example less than the width of average human adult fingers, to the inner surface of the pull handle.

### BRIEF DESCRIPTION OF THE DRAWINGS

Preferred embodiments of the invention will now be described, by way of examples only, with reference to the accompanying drawings in which:

FIG. 1 is a front view of a first embodiment of a lever and pull handle arrangement;

FIG. 2 is a side view of the arrangement shown in FIG. 1;

FIG. 3 is a front view of a second embodiment of a lever and pull handle arrangement;

FIG. 4 is a side view of the arrangement shown in FIG. 3;

FIG. 5 is a front view of a third embodiment of a lever and pull handle arrangement;

FIG. 6 is a side view of the arrangement shown in FIG. 5.

FIG. 7 is a front view of a fourth embodiment of a lever and pull handle arrangement;

FIG. 8 is a side view of the arrangement shown in FIG. 7;

FIG. 9 is a front view of a fifth embodiment of a lever and pull handle arrangement;

FIG. 10 is a side view of the arrangement shown in FIG. 9; and

FIG. 11 is a top view of the arrangement shown in FIG. 9.

### DETAILED DESCRIPTION OF THE PREFERRED EMBODIMENTS

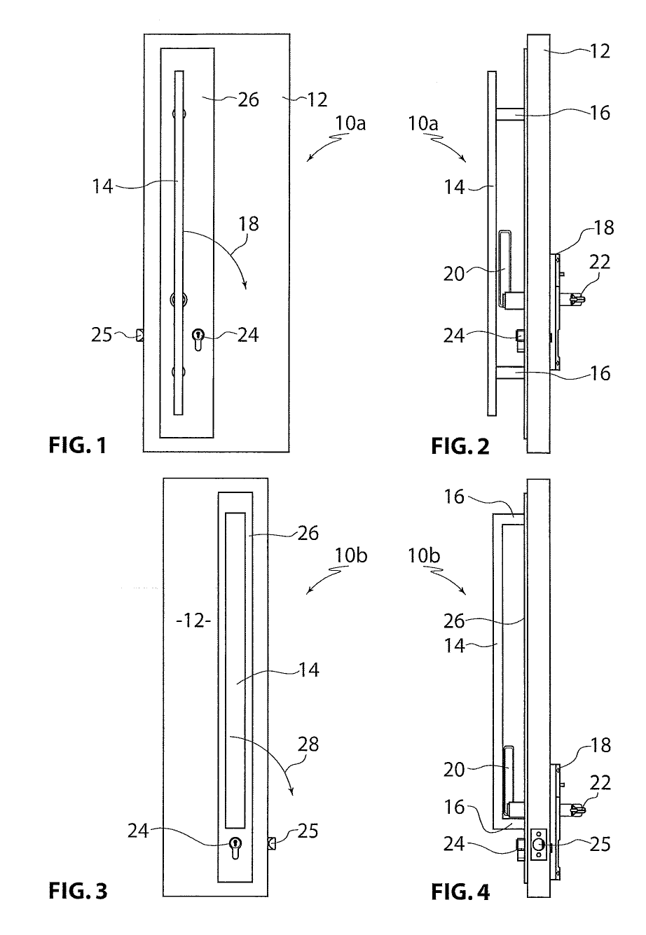

FIGS. 1 and 2 show a first embodiment of a lever and pull handle arrangement 10a installed on a section of a door 12. The door section 12 has, on one (outer) side, an elongate pull handle 14, of round cross-section. The handle 14 is about 600 mm long and is fixed to, and spaced apart from, the adjacent surface of the door section 12 by legs 16 near each end of the handle 14. The longitudinal axis of the handle 14 is vertical.

A latch and/or lock assembly 18, in the exemplary form of a multiple mode lock marketed by the Applicant under the trade mark TRILOCK, is also mounted to the door section 12.

As is best seen in FIG. 2, on the (outer) side of the door section 12 with the handle 14, the TRILOCK 18 includes a lever actuator 20 orientated, when in the rest or return position, with its longitudinal axis substantially vertical. As is best seen in FIG. 1, the handle 14 substantially conceals the lever 20, particularly when viewed in the direction of the front of the door section 12. The outer surface or edge of the lever 20 is in close proximity, for example about 3 to 6 mm less than the width of average human adult fingers, from the inner edge or surface of the handle 14.

The TRILOCK 18 also includes a lever actuator 22 on the other (inner) side of the door section 12, which has its longitudinal axis substantially horizontal, as is traditional in locks of this type.

The TRILOCK 18 also includes a key cylinder 24, having a rotational axis which is offset to one side from the rotational axis of the levers 20 and 22, and a bolt 25, which can be withdrawn by the levers 20, 22 and the key cylinder 24.

The door section 12 also includes a face plate 26 mounted thereto. The TRILOCK 18 is mounted within a door at a traditional height above the floor, being approximately the waist height of an average human adult (e.g. 1000 mm). As a result, when a person grips the handle 14 and attempts to open the door their hand is positioned at approximately the same height as the lever 20. Further, as their fingertips extend around the periphery of the handle 14, they encounter the handle 20. The lever 20 can then be pivoted, as indicated by arrow 28, to actuate the TRILOCK 18 to withdraw the bolt 25, and allow the door to be opened.

The possibility of the user's fingers not touching the lever 20 is very unlikely as the outer surface or edge of the lever 20 less than the width of average human adult fingers from the inner edge or surface of the handle 14 (i.e. the user's fingers can not pass through the gap between the lever 20 and the handle 14).

Accordingly, notwithstanding that the lever 20 is generally concealed/obscured by the handle 14, thereby advantageously providing a neat, modern, uncluttered aesthetic, the operation of the lever 20 (and thus the TRILOCK 18) also advantageously remains intuitive to a first time user.

In the event that a user was unfamiliar with the arrangement 10a and placed their hand on the handle 14 at a position remote from the lever 20 and was unable to open the door, it is expected that an intuitive option for investigation would be to look behind the handle 14, thereby revealing the lever 20. This of course is only likely to be problematic the first time a user encounters the door with the arrangement 10a.

FIGS. 3 and 4 show a second embodiment of a lever and handle arrangement 10b. The arrangement 10b is similar in construction and operation to the arrangement 10a shown in FIGS. 1 and 2 and like features have been indicated with like reference numerals. However, in the arrangement 10b the elongate handle 14 is of rectangular cross-section, and has the legs 16 at each end. Also, the rotational axis of the key cylinder 24 is offset below the rotational axis of the levers 20 and 22.

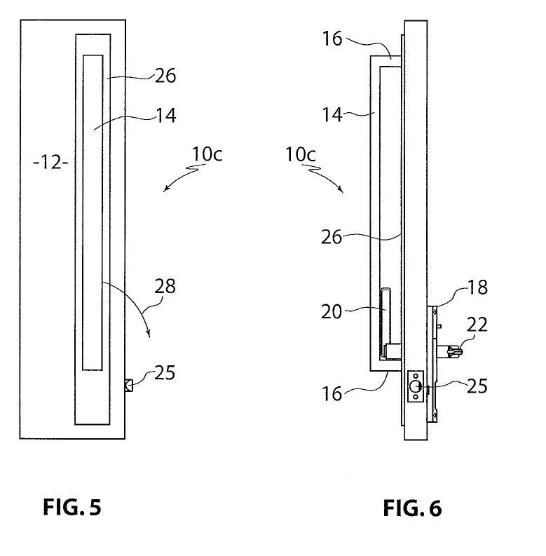

FIGS. 5 and 6 show a third embodiment of a lever and handle arrangement 10c. The arrangement 10c is similar in construction and operation to the arrangement 10b shown in FIGS. 3 and 4 and like features have been indicated with like reference numerals. However, the arrangement 10c is for a passage door that only requires a latching function and thus does not include a key cylinder.

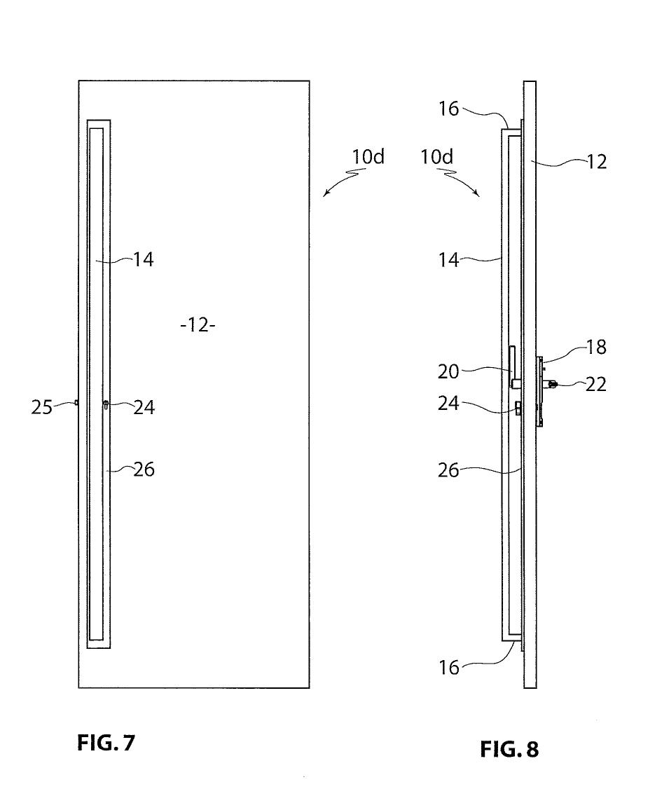

FIGS. 7 and 8 show a fourth embodiment of a lever and handle arrangement 10d. The arrangement 10d is similar in construction and operation to the arrangement 10a shown in FIGS. 1 and 2 and like features have been indicated with like reference numerals. However, in the arrangement 10d, the elongate handle 14 extends over nearly the entire height of the door section 12.

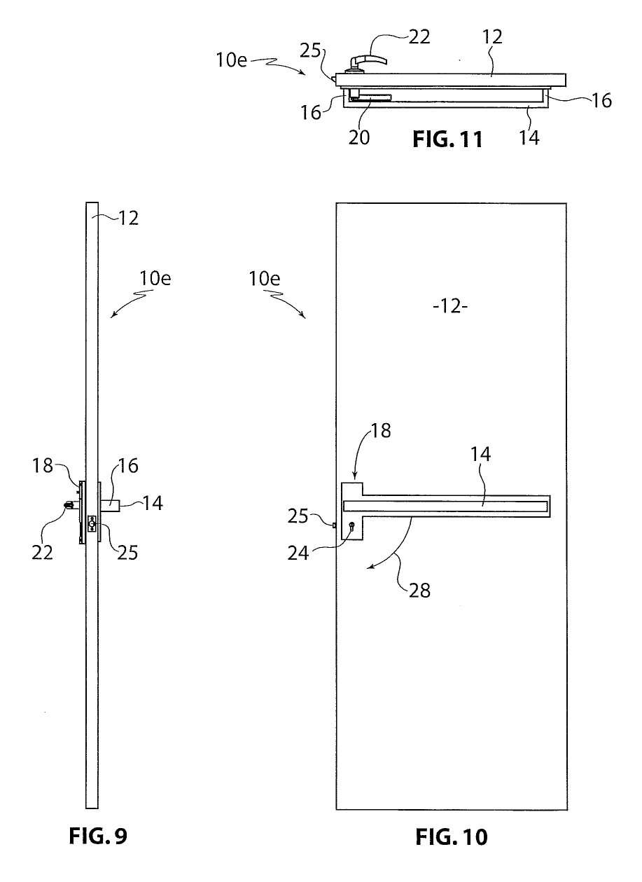

FIGS. 9 to 11 show a fifth embodiment of a lever and handle arrangement 10e. The arrangement 10e is similar in construction and operation to the arrangement 10a shown in FIGS. 1 and 2 and like features have been indicated with like reference numerals. However, in the arrangement 10e, the elongate handle 14 has a horizontal longitudinal axis. Similarly, the lever 20, when in the rest position, also has a horizontal longitudinal axis. The handle 14 extends over nearly the entire width of the door section 12.

Although the invention has been described with reference to preferred embodiments, it will be appreciated by persons skilled in the art that the invention may be embodied in many other forms. For example, the lever and handle arrangements can be used with many different types of latches and locks.

We claim:

1. A lever and pull handle arrangement for a door, the arrangement including:
a lever adapted for actuating a latch and/or lock assembly, the lever having a longitudinal axis and a rotational axis; and
an elongate pull handle having a longitudinal axis,
wherein the lever and the pull handle are mountable on the door with their longitudinal axes substantially aligned and, when viewed in the direction of the rotational axis towards the door, with the pull handle substantially concealing the lever from view.

2. A lever and pull handle arrangement for a door, the arrangement including:
a lever adapted for actuating a latch and/or lock assembly, the lever having a longitudinal axis; and
an elongate pull handle having a longitudinal axis,
wherein the lever and handle are mountable on the door with the longitudinal axes of the lever and pull handle substantially aligned and with the lever positioned between the door and the handle.

3. The lever and pull handle arrangement as claimed in claim 1, wherein the pull handle is mounted to the door with its longitudinal axis vertical.

4. The lever and pull handle arrangement as claimed in claim 1, wherein when in the rest position, the lever is mounted to the door with its longitudinal axis vertical.

5. The lever and pull handle arrangement as claimed in claim 1, wherein the pull handle is mounted to the door with its longitudinal axis horizontal.

6. The lever and pull handle arrangement as claimed in claim 1, wherein when in the rest position, the lever is mounted to the door with its longitudinal axis horizontal.

7. The lever and pull handle arrangement as claimed in claim 1, wherein the arrangement includes a key cylinder positioned to one side of the handle.

8. The lever and pull handle arrangement as claimed in claim 1, wherein the arrangement includes a key cylinder positioned beneath the handle.

9. A lever and handle arrangement for a door, the arrangement including:
a lever adapted for actuating a latch and/or lock assembly, the lever having a longitudinal axis that is vertical when in the rest position; and
an elongate pull handle having a longitudinal axis that is vertical,
wherein the lever and the pull handle are mountable on the door with, when viewed in the direction of the front of the door, the pull handle substantially concealing the lever.

10. A lever and handle arrangement for a door, the arrangement including:
a lever adapted for actuating a latch and/or lock assembly, the lever having a longitudinal axis that is horizontal when in the rest position; and
an elongate pull handle having a longitudinal axis that is horizontal,
wherein the lever and the pull handle are mountable on the door with, when viewed in the direction of the front of the door, the pull handle substantially concealing the lever.

11. The lever and pull handle arrangement as claimed in claim 9, wherein the longitudinal axes of the lever and the pull handle are substantially aligned.

12. A lever and handle arrangement for a door, the arrangement including:
a lever adapted for actuating a latch and/or lock assembly, the lever having a longitudinal axis that is vertical when in the rest position; and
an elongate pull handle having a longitudinal axis that is vertical,
wherein the lever and the pull handle are mountable on the door with the longitudinal axes of the lever and the pull handle substantially aligned and with the lever positioned between the door and the pull handle.

13. A lever and handle arrangement for a door, the arrangement including:
a lever adapted for actuating a latch and/or lock assembly, the lever having a longitudinal axis that is horizontal when in the rest position; and
an elongate pull handle having a longitudinal axis that is horizontal,
wherein the lever and the pull handle are mountable on the door with the longitudinal axes of the lever and the pull handle substantially aligned and with the lever positioned between the door and the pull handle.

14. The lever and pull handle arrangement as claimed in claim 12, wherein the pull handle includes a pair of legs adapted to space the pull handle from the door.

15. The lever and pull handle arrangement as claimed in claim 12, wherein the lever is mounted with its outer surface in close proximity to the inner surface of the pull handle.

16. The lever and pull handle arrangement as claimed in claim 15, wherein the lever is mounted with its outer surface less than the width of an average human adult finger from the inner surface of the handle.
